(19) United States
(12) Patent Application Publication
(10) Pub. No.: US 2008/0165404 A1
(43) Pub. Date: Jul. 10, 2008

(54) System and method for providing touchscreen functionality in digital light processing video unit

(76) Inventors: Kevin Xie, Shenzhen City (CN); James Lyst, Indianapolis, IN (US); Jingbo Cai, Carlsbad, CA (US)

Correspondence Address: International IP Law Group, P.O. BOX 691927, HOUSTON, TX, 77269-1927, US

(21) Appl. No.: 11/879,546

(22) Filed: Jul. 18, 2007

(30) Foreign Application Priority Data
Jul. 28, 2006 (CN) 200610103952.1

(51) Int. Cl. G02B 26/08; H04N 5/74

(52) U.S. Cl. 359/223; 348/771; 348/E05.137

(57) ABSTRACT

There is provided a system and method for providing touchscreen functionality in a digital light processing system. More specifically, in one embodiment, there is provided a method, comprising assigning each of a plurality of micromirrors (17) on a digital micromirror device (18) a unique identifier, projecting light toward at least one of the plurality of micromirrors (17a), and actuating the at least one micromirror (17a) in a pattern corresponding to its identifier.

### CROSS REFERENCE TO RELATED APPLICATION

This application claims priority to Chinese (CN) National Patent Application No. CN 200610103952.1 filed on Jul. 28, 2006, which is incorporated by reference as though completely set forth herein.

### FIELD OF THE INVENTION

The present invention relates generally to projecting video images onto a screen. More specifically, the present invention relates to providing touchscreen functionality in a Digital Light Processing (“DLP”) video unit.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Digital Light Processing (“DLP”) is a display technology that employs an optical semiconductor, known as a Digital Micromirror Device (“DMD”) to project video onto a screen. DMDs typically contain an array of hundreds of thousands or more microscopic mirrors mounted on microscopic hinges. Each of these mirrors is associated with at least one point on the screen, known as a pixel. By varying the amount of light that is reflected off each of these mirrors, it is possible to project video onto the screen. Specifically, by electrically actuating each of these hinge-mounted microscopic mirrors, it is possible to either illuminate a point on the screen (i.e., “turn on” a particular micromirror) or to leave that particular point dark by reflecting the light somewhere else besides the screen (i.e., “turn off” the micromirror). Further, by varying the amount of time a particular micromirror is turned on, it is possible to create a variety of gray shades. For example, if a micromirror is turned on for longer than it is turned off, the pixel that is associated with that particular micromirror will have a light gray color; whereas if a particular micromirror is turned off more frequently than it is turned on, that particular pixel will have a darker gray color. In this manner, video can be created by turning each micromirror on or off several thousand times per second. Moreover, by sequentially shining red, green, and blue at the micromirrors instead of white light, it is possible to generate millions of shades of color instead of shades of gray.

As most people as aware, touchscreen displays are a growing trend in modern display units and computers. Unlike traditional interfaces, such as a keyboard, mouse, remote control, and the like, touchscreens enable a user to directly interact with the screen of a display. Advantageously, touchscreen systems are typically more intuitive to control than traditional display technologies (e.g., selections are made by simply pointing at the desired item on the screen). Moreover, beyond control, many touchscreens enable users to write on the screen—in much the same way that one would write on a piece of paper. Amongst other uses, this functionality may enable the display to be used as a digital “chalkboard” or to be used as a canvas for illustrators or artists. As mentioned above, the touchscreen interface is typically more intuitive to use than conventional devices that provide this functionality (e.g., graphic tablet computers and the like).

Unfortunately, conventional systems for providing touchscreen functionality are typically expensive and/or provide relative low resolution. For example, many conventional touchscreen systems employ a grid of capacitors and/or resistors that are configured to detect physical contact with the screen. Disadvantageously, the detection grid must be precisely assigned with the display screen during assembly of the video unit. This increases the assembly cost for the video unit. Moreover, the resolution of this type of touchscreen system is based on the resolution of the detection grid not on the display resolution of the video unit itself. As such, the resolution of the touchscreen grid is typically much lower than the resolution of the display. Other conventional touchscreen technologies, such as surface acoustic wave systems, near field imaging systems, and infrared system have similar disadvantages. An improved system and method for providing touchscreen functionality in a DLP video unit is desirable.

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

There is provided a system and method for providing touchscreen functionality in a digital light processing system. More specifically, in one embodiment, there is provided a method, comprising assigning each of a plurality of micromirrors on a digital micromirror device a unique identifier, projecting light toward at least one of the plurality of micromirrors, and actuating the at least one micromirror in a pattern corresponding to its identifier.

### BRIEF DESCRIPTION OF THE DRAWINGS

Advantages of the invention may become apparent upon reading the following detailed description and upon reference to the drawings in which:

FIG. 1 is a block diagram of a digital light processing touchscreen video unit in accordance with an exemplary embodiment of the present invention;

FIG. 2 is a diagram of a color wheel in accordance with an exemplary embodiment of the present invention; and

FIG. 3 is a flow chart illustrating an exemplary technique for enabling touchscreen functionality in a digital light processing video unit in accordance with an exemplary embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

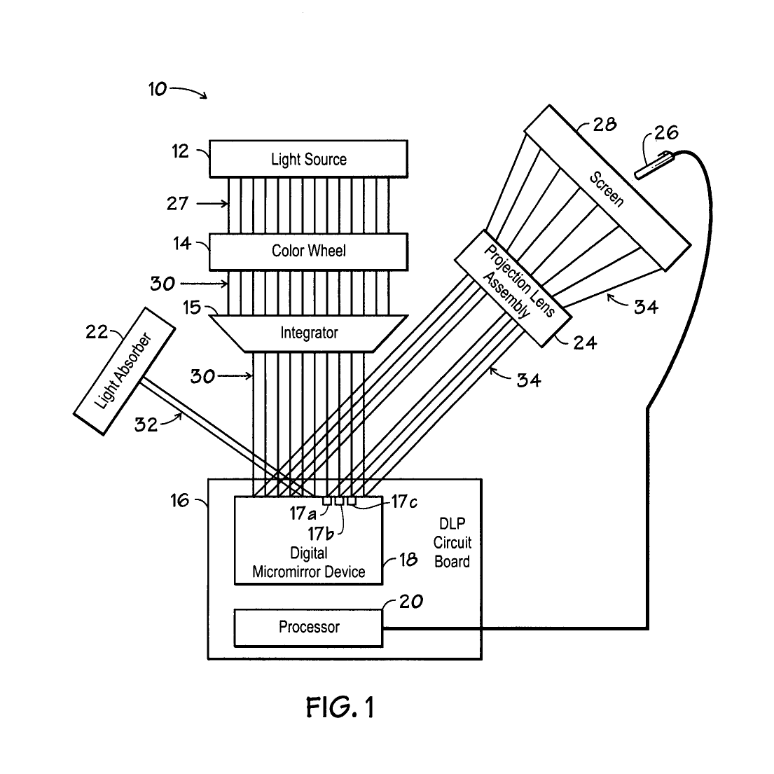

Turning initially to FIG. 1, a block diagram of a DLP touchscreen video unit in accordance with an exemplary embodiment of the present invention is illustrated and generally designated by a reference numeral 10. In one embodiment, the video unit 10 may comprise a DLP projection television. In another embodiment, the video unit 10 may comprise a DLP-based video or movie projector. In still other embodiments, the video unit may comprise other suitable DLP-based systems—or the like.

The video unit 10 may include a light source 12. The light source 12 may include any suitable form of lamp or bulb capable of projecting white or generally white light 28. In one embodiment, the light source 12 may include a metal halide, mercury vapor, or ultra high performance (“UHP”) lamp. In alternate embodiments, the light source 12 may include one or more light emitting diodes (either white or colored). In one embodiment, the light source 12 is configured to project, shine, or focus the white light 28 into one static location as described further below.

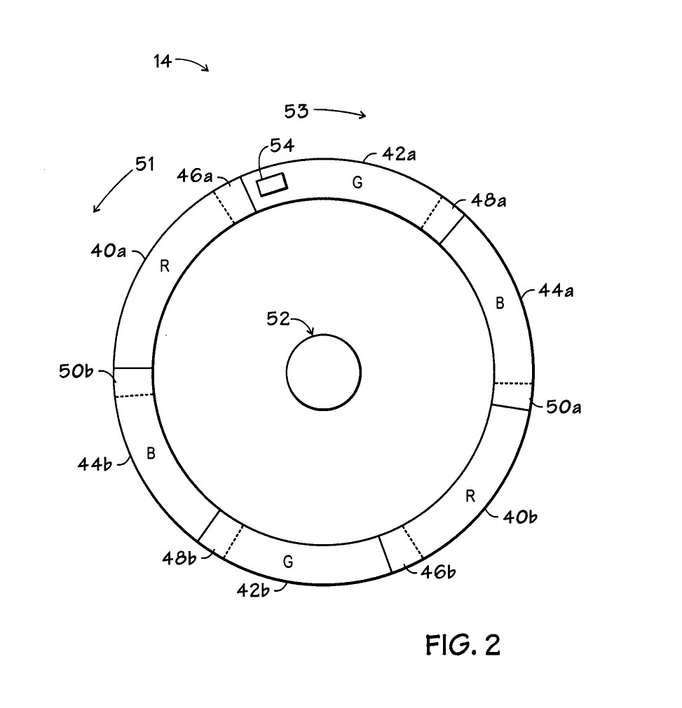

As illustrated in FIG. 1, the exemplary video unit 10 also comprises a color wheel 14 aligned in an optical line of sight with the light source 12. FIG. 2 is a diagram of the color wheel 14 in accordance with an exemplary embodiment of the present invention. The color wheel 14 may comprise a variety of color filters 40a, 40b, 42a, 42b, 44a, and 44b arrayed as arcuate regions on the color wheel 14. Specifically, in the illustrated embodiment, the color wheel 14 comprises color filters 40a, 40b, 42a, 42b, 44a, and 44b configured to convert the white light 28 into one of the three primary colors of light: red, green, or blue. In particular, the illustrated embodiment of the color wheel 14 comprises two red color filters 40a and 40b, two green color filters 42a and 42b, and two blue color filters 44a and 44b.

It will be appreciated that in alternate embodiments, the specific colors of the filters 40a, 40a, 42a, 42b, 44a, and 44b may be altered or the number of filters may be altered. For example, in one alternate embodiment, the color wheel 14 may comprise only one red color filter 40a, one green color filter 42b, and one blue color filter 44a. In this embodiment, the arcuate regions occupied by the color filters 44a, 44b, and 44c may be approximately twice as long (as measured along the circumference of the color wheel 14) than the color filters 40a, 42b, and 44a depicted in FIG. 2. In still other embodiments, the color filters 40a, 40b, 42a, 42b, 44a, and 44b may occupy either more or less of the surface area of the color wheel depending on the configuration and function of the video unit 10.

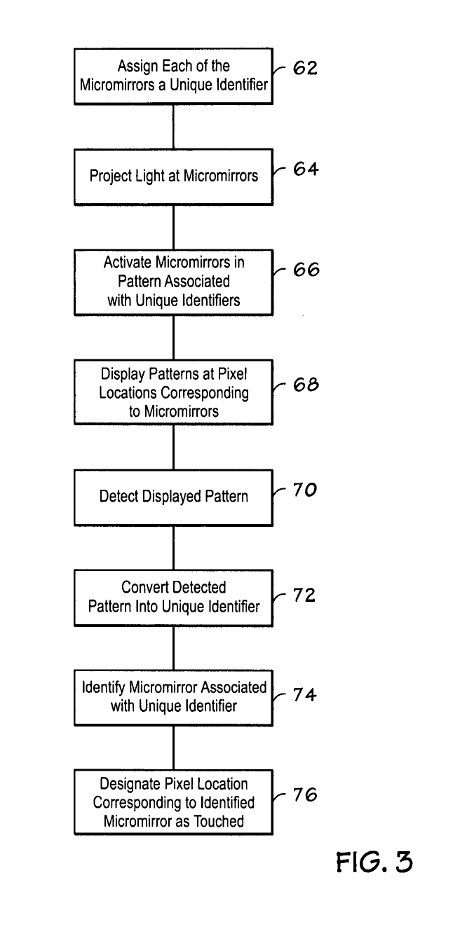

In addition, as illustrated in FIG. 2, each of the color filters 40a, 40b, 42a, 42b, 44a, and 44b may include a sub-sector 46a, 46b, 48a, 48b, 50a, and 50b, respectively. As will be described in greater detail below with regard to FIG. 3, in one embodiment, the sub-sectors 46a, 46b, 48a, 48b, 50a, and 50b enable the video unit 10 to provide touchscreen functionality. In one embodiment, the sub-sectors 46a, 46b, 48a, 48b, 50a, and 50b occupy approximately ten percent of each of the color filters 40a, 40b, 42a, 42b, 44a, and 44b. It will be appreciated, however, that the size and location of each of the sub-sectors 46a, 46b, 48a, 48b, 50a, and 50b illustrated in FIG. 2 is merely exemplary. As such, in alternate embodiments, the sub-sectors 46a, 46b, 48a, 48b, 50a, and 50b maybe vary in size and location within the color filters 40a, 40b, 42a, 42b, 44a, and 44b. Moreover, it will be understood that the sub-sectors may be a logical sub-section of the color filters 40a, 40b, 42a, 42b, 44a, and 44b (i.e., the sub-sectors 46a, 46, 48a, 48b, 50a, and 50b may not be separated from the color filter by any visible or physical divider).

Turning next to the operation of the color wheel 14, each of the filters 40a, 40b, 42a, 42b, 44a, and 44b is designed to convert the white light 28 generated by the light source 12 into colored light 30. In particular, the color wheel 14 may be configured to rapidly spin in a counterclockwise direction 51 around its center point 52. In one embodiment, the color wheel 14 rotates 60 times per second. As described above, the light source 12 may be configured to focus the white light 28 at the color wheel 14. On the opposite side of the color wheel from the light source 12, there may be an integrator 15, which is also referred to as a light tunnel. In one embodiment, the integrator 15 is configured to the evenly spread the colored light 30 across the surface of a DMD 18. As such, those skilled in the art will appreciate that most, and possibly all, of the light that will be reflected off the DMD 18 to create video will pass through the integrator 15.

Because the integrator 15 is fixed and the color wheel 14 rotates, the light that will enter the integrator 15 can be illustrated as a fixed area 54 that rotates around the color wheel 14 in the opposite direction from the color wheel's direction of rotation. For example, as the color wheel 14 rotates in the counterclockwise direction 51, the fixed area 54 rotates through each the filters 40a, 40b, 42a, 42b, 44a, and 44b in the clockwise direction 53. As such, those skilled in the art will recognize that the colored light 30 entering the integrator 15 will rapidly change from red to green to blue to red to green to blue with each rotation of the color wheel 14 as the fixed area 54 passes through each of the color filters 40a, 40b, 42a, 42b, 44a, and 44b. In other words, because the light source 12 is stationary, the counterclockwise rotation of the color wheel 14 causes the fixed area 54 to rotate in a clockwise direction 53 through the colors of the color wheel. In alternate embodiments, the color wheel 14 itself may rotate in the clockwise direction 53. Those of ordinary skill in the art will appreciate that the size and shape of the fixed area 54 is merely illustrative. In alternate embodiments, the size and shape of the fixed area 54 may be different depending on the optical design of the system.

Returning now to FIG. 1, the video unit 10 may also comprise a DLP circuit board 16 arrayed within an optical line of sight of the integrator. The DLP circuit board 16 may comprise the DMD 18 and a processor 20. As described above, the DMD 18 may include a multitude of micromirrors 17a, 17b, and 17c, for example, mounted on microscopic, electrically-actuated hinges that enable the micromirrors 17 to tilt between a turned on position and turned off position.

The colored light 30 that reflects off a turned on micromirror (identified by a reference numeral 34) is reflected to a projecting lens assembly 24 and then projected on to a screen 28 for viewing. On the other hand, the colored light that reflects off of a turned off micromirror (identified by a reference numeral 32) is directed somewhere else in the video besides the screen 28, such as a light absorber 22. In this way, the pixel on the screen 28 that corresponds to a turned off micromirror does not receive the projected colored light 30 while the micromirror is turned off.

The DMD 18 may also be coupled to the processor 20. In one embodiment, the processor 20 may receive a video input and direct the micromirrors 17 on the DMD 18 to turn on or off, as appropriate, to create a video image. In addition, as described in greater detail below, the processor 20 may also be configured to direct the micromirrors 17 on the DMD 18 to turn on or off, as appropriate, to project a unique light pattern that may be used to identify pixel locations corresponding to each individual micromirror 17. It will be appreciated, however, that, in alternate embodiments, the processor 20 may be located elsewhere in the video unit 10.

As illustrated in FIG. 1, the video unit 10 may also include a light pen 26. As will be described in greater detail below, the light pen 26 may enable touchscreen functionality in the video unit 10. More specifically, when the light pen 26 touches a pixel location the screen 28, it may be configured to receive the unique light pattern projected at that pixel location. As such, in one embodiment, the light pen 26 may include one or more photodiodes that are configured to receive light and convert it into an electrical signal. However, in other embodiments, other suitable light reception and detection devices may be employed.

The light pen 26 may then be configured to transmit the unique light pattern to the processor 20 or another suitable computational unit within the video unit 10. In this illustrated embodiment, the connection between the light pen 26 and the processor is via a wire or cable. In alternate embodiments, however, this connection may be a wireless connection. When the processor 20 receives the unique light pattern, it can identify the micromirror 17 that projected the unique light pattern and, in turn, identify the pixel location where the light pen 26 touched the screen 28. The location of this “touch” can then be transmitted to the DMD 18 to enable “writing” on the screen 28, used to indicate a selection to a computer, or employed for another suitable touchscreen application.

FIG. 3 is a flow chart illustrating an exemplary technique 60 for enabling touchscreen functionality in a digital light processing video unit in accordance with embodiments of the present invention. In one embodiment, the technique 60 may be performed by the video unit 10. In alternate embodiments, however, other suitable types of video units, displays, computers, and so forth may execute the technique 60.

As indicated in block 62, the technique 60 may begin by assigning each of the micromirrors 17 on the DMD 18 a unique identifier. For example, the micromirrors 17 may be assigned a row and column identifier representative of each micromirror's location on DMD 18. Alternatively, each of the micromirrors 17 may be assigned an individual numeric or alphanumeric identifier. For example, each of the micromirrors may be assigned a sequential number. In still other embodiments, other suitable identification schemes may be used to assign a unique identifier to each of the micromirrors 17.

Next, the light source 12 may be configured to project light at the micromirrors 17, as indicated in block 64. As illustrated in FIG. 1, in one embodiment, the light source 12 may project white light 28 through the rotating color wheel 14. After the light source 12 begins projecting light, the DMD 18 may actuate each of the micromirrors 17 in a pattern associated with the unique identifier associated with that particular micromirror 17, as indicated in block 66. For example, if the unique identifier associated with the micromirror 17a is column 517 and row 845, the micromirror 17a may be configured to actuate in such a way to communicate the unique identifier. More specifically, the micromirror 17a may be configured transmit the bit sequence 1000000101 (517 in binary) then the bit sequence 1101001101 (845 in binary), where the 1's correspond to the micromirror 17 in the on position and the 0's correspond the off position. Similarly, if the unique identifier associated with the micromirror 17b is column 518 and row 845, the micromirror 17b may be configured to transmit the bit sequence 1000000110 (518 in binary) then the bit sequence 1101001101 (845 in binary).

As described above, however, the micromirrors 17 are also configured to turn on and off, as appropriate, to project video images onto the screen 28. As such, micromirrors 17 may be configured to divide their time between projecting video images and projecting their unique identifier. For example, in the embodiment illustrated in FIG. 1, the micromirrors 17 may be configured to project the bit sequences associated with their individual unique identifier when the fixed area 54 is passing through the sub-sectors 46a, 46b, 48a, 48b, 50a, and 50b and to project video images when the fixed area is passing through the remainder of the color filters 40a, 40b, 42a, 42b, 44a, and 44b. Moreover, in non-color wheel embodiments, the video unit may be configured to designate a certain percentage (e.g., ten percent) of each color to project the bit sequences.

For example, in one embodiment, the micromirrors 17 may be configured to project two bits during each of the sub-sectors 46a, 46b, 48a, 48b, 50a, and 50b for a total of twelve bits per rotation of the color wheel 14. In this embodiment, every odd rotation of the color wheel 14 may be used to project the bit sequence for the row component of the unique identifier and every even rotation of the color wheel 14 may be used to project bit sequence for the column component of the unique identifier. Accordingly, an array of 4096 (the largest number possible with twelve bits) by 4096 unique row and column micromirror addresses can be coded. Further, in alternate embodiments, other suitable coding schemes can be employed. For example, in one embodiment, only one bit may be projected during each of the sub-sectors 46a, 46b, 48a, 48b, 50a, and 50b and more rotations of the color wheel 14 may used to compile each bit sequence (e.g., two rotations for the column bit sequence and two rotations for the row bit sequence). Furthermore, in still other embodiments, other suitable coding techniques may be used.

Returning now to FIG. 3, as the light 30 reflects off the micromirrors 17, the bit sequences for each of the micromirrors 17 will be displayed as light patterns at the pixel locations on the screen 28 that correspond to each of the micromirrors 17 (block 68). The light pen 26 may then be configured to detect these light patterns, as indicated by block 72. As described above, the light pen 26 may include one or more photodiodes that are configured to convert the light patterns into a digital signal. In addition, in one embodiment, the light pen 26 may also include an activation switch or button that enables a user to choose whether touching the light pen 26 to screen will trigger the touchscreen functionality.

Once the light pen 26 has received the light pattern, the light pattern may be converted back into the unique identifier, as indicated by block 72. In one embodiment, the light pen 26 may be synchronized with the color wheel 14 and, thus, configured to know when the light being projected at the screen 28 is part of the identifier as opposed to being part of the video image. As such, the light pen 26 may be configured to isolate the sections of the digital signal (e.g., binary bits) that correspond to light that was projected during the sub-sectors 46a, 46b, 48a, 48b, 50a, and 50b. Once these sections are isolated, their bits may be combined together to form the above-described bit sequences that can be converted into the unique identifier for one of the micromirrors 17. Alternatively, the light pen 26 may be configured to transmit the bits for the entire rotation of the color wheel 14 to the processor 20 or other suitable computational device. The processor 20 may then be configured isolate the bits that occurred during the sub-sectors 46a, 46b, 48a, 48b, 50a, and 50b.

Next, the processor 20 (or other suitable computational device) will identify the micromirror 17 associated with the unique identifier, as indicated in block 74. In one embodiment, identifying the micromirror 17 may involve determining which micromirror was assigned the particular unique identifier in block 62 above.

After the micromirror 17 associated with the unique identifier has been identified, the pixel location on the screen 28 that corresponds to that micromirror 17 may be designated as “touched,” as indicated by block 76. In one embodiment, the color of the video image may be altered in the touched location. For example, all of the pixel locations touched by the light pen 26 may be changed to black, white, or another suitable color. In this way, the video unit 10 enables a user to write on the screen. Moreover, because the resolution of the light pen 26 is the same as the display resolution of the video unit 10, the light pen 26 enables writing on the screen at resolutions far in excess of conventional graphics tablets at considerably less cost.

In another embodiment, the touched pixel location may be transmitted to a computer or other electronic device (not shown) that is using the video unit 10 as a display. In this way, the light pen 26 may be used to select or choose items or icons shown on the screen 28 to replace or supplement a mouse, keyboard, or other control device. Alternatively, this embodiment may also be employed in conjunction with handwriting recognition systems to allow users to write text or images directly into files or documents.

As described above, the pixel location on the screen 28 that corresponds to the micromirror 17 may be designated as “touched.” It will be appreciated, however, that in embodiments of the video unit 10 employing Smooth Picture™ technology (i.e., including a modulator that shifts light from one micromirror 17 to a plurality of pixel locations), the position of the modulator may also be considered when determining the pixel location corresponding to the micromirror 17. In other words, before designating a pixel location as touched, the video unit 10 will determine both the micromirror 17 and the position of the modulator as the one micromirror 17 may provide light for a plurality of pixel locations.

As described above, the video unit 10 provides DLP touchscreen functionality with high resolution at a relatively low cost. Advantageously, the video unit 10 requires no modification to the conventional DLP optical path or light engine structure and requires no special screen. As such, the video unit 10 can provide enhanced touchscreen functionality for only a slightly higher cost than conventional DLP systems.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method, comprising:
assigning each of a plurality of micromirrors (17) on a digital micromirror device (18) a unique identifier;
projecting light toward at least one of the plurality of micromirrors (17a); and
actuating the at least one micromirror (17a) in a pattern corresponding to its identifier.

2. The method of claim 1, wherein the actuating comprises actuating the at least one micromirror (17a) in a binary pattern, wherein the identifier is a numerical identifier.

3. The method of claim 1, comprising:
reflecting light from the at least one micromirror to a pixel location associated with the at least one micromirror (17a), wherein the reflecting projects the pattern onto a screen (28) as a light pattern;
detecting the light pattern; and
correlating the light pattern into the corresponding unique identifier.

4. The method of claim 3, comprising:
isolating a portion of the light pattern that was generated during a sub-sector (46a, 46b, 48a, 48b, 50a, or 50b) of a color wheel (14); and
converting the light pattern into a sequence of bits, wherein the unique identifier comprises the sequence of bits.

5. The method of claim 3, comprising:
identifying the at least one micromirror (17a) corresponding to the identifier; and
designating the pixel location associated with the one micromirror (17) as a touched pixel location.

6. The method of claim 3, comprising changing a display color of the touched pixel location.

7. The method of claim 3, comprising transmitting the location of the touched pixel to an electronic device.

8. The method of claim 1, comprising actuating the plurality of micromirrors (17), wherein each of the plurality of micromirrors (17) actuates in a pattern corresponding to its unique identifier.

9. The method of claim 1, wherein the assigning comprises assigning each of the plurality of micromirrors (17) an identifier corresponding to the row and column location of each individual micromirror (17).

10. A video unit (10), comprising:
a screen (28) including a plurality of pixel locations; and
a digital micromirror device (18) including a plurality of micromirrors (17) each of which is associated with at least one of the pixel locations, wherein the digital micromirror device (18) is configured to actuate each individual micromirror (17) in a pattern that identifies a location of that micromirror (17) on the digital micromirror device (18).

11. The video unit (10) of claim 10, comprising a processor (20) configured to assign the patterns to each of the micromirrors (17).

12. The video unit (10) of claim 10, wherein the micromirror (17) is configured to project the pattern onto one of the pixel locations on the screen (28) as a light pattern.

13. The video unit (10) of claim 12, comprising:
a light pen (26) configured to receive the light pattern; and
a processor (20) configured to identify the micromirror (17) associated with the received light pattern.

14. The video unit (10) of claim 13, wherein the processor (20) is configured:
to determine the pixel location on the screen (28) associated with the identified micromirror (17); and
to designate the determined pixel location as touched.

15. The video unit (10) of claim 14, wherein the processor (20) is configured to determine the pixel location on the screen (28) based at least partially on a position of a modulator.

16. The video unit (10) of claim 13, comprising a color wheel (14), wherein the processor (20) is configured to identify the micromirror (17) using light associated with one or more sub-sectors (46a, 46b, 48a, 48b, 50a, and 50b) of the color wheel (14).

17. The video unit (10) of claim 13, wherein the light pen (26) is wireless connected to the processor (20).

18. A method, comprising:
assigning each of a plurality of micromirrors (17) a row and column address based on their individual locations on a digital micromirror device (18); and
actuating each of the plurality of micromirrors (17) in a pattern that represents the row and column address.

19. The method of claim 18, comprising:
projecting the patterns onto a screen (28) at a plurality of pixel locations, wherein each of the pixel locations is associated with one of the plurality of micromirrors (17); and
receiving one of the patterns.

20. The method of claim 19, comprising:
determining the pixel location associated with the determined micromirror (17); and
designating the determined pixel location as a touched pixel location.
